(19) United States
(12) Patent Application Publication
(10) Pub. No.: US 2011/0200819 A1
(43) Pub. Date: Aug. 18, 2011

(54) CARBON FIBER COMPOSITE MATERIAL, AND BRAKE MEMBER, STRUCTURAL MEMBER FOR SEMICONDUCTOR, HEAT RESISTANT PANEL AND HEAT SINK USING THE CARBON FIBER COMPOSITE MATERIAL

(75) Inventors: Kazuya BABA, Hitachi-shi (JP); Kazuyuki Akasaka, Hitachinaka-shi (JP)

(73) Assignee: Hitachi Chemical Company, Ltd.

(21) Appl. No.: 13/030,648

(22) Filed: Feb. 18, 2011

(30) Foreign Application Priority Data
Feb. 18, 2010 (JP) P2010-033577

(51) Int. Cl. B32B 9/00

(52) U.S. Cl. 428/367

(57) ABSTRACT

There are provided a carbon fiber composite material having excellent mechanical properties such as toughness and strength, and a brake member, a structural member for semiconductor, a heat resistant panel and a heat sink, all of which use this carbon fiber composite material.

The carbon fiber composite material is obtained by mixing carbon fiber with a resin, subsequently molding the mixture and carbonizing the molded product, and subjecting the resultant carbonized product to melt impregnation with silicon, in which the lattice spacing d002 of the carbon (002) plane of the carbon fiber as measured by an X-ray diffraction method is 3.46 to 3.51. A brake member, a structural member for semiconductor, a heat resistant panel and a heat sink, all of which use this carbon fiber composite material, are provided.

### BACKGROUND OF THE INVENTION

1. Field of the Invention

The present invention relates to a carbon fiber composite material, and more particularly, to a carbon fiber composite material which is suitable for many applications such as a brake member, a structural member for semiconductor, a structural member for high temperature use in aerospace, a heat resistant panel, a heat sink, a member for gas turbine, a material for nuclear fusion furnace, a member for furnace interior, and a heater member.

2. Description of the Related Art

In recent years, ceramics such as silicon carbide have been widely used in, for example, uses in a high temperature corrosion resistant member, a heater material, an abrasion resistant member, and applications such as a polishing agent, owing to the materials' excellent light weight, heat resistance, abrasion resistance, corrosion resistance, oxidation resistance and the like. However, since ceramics have low fracture toughness, they are not yet to be put into practical use as structural members. Recently, studies on carbon fiber composite materials made into composites with reinforcing material such as carbon fiber have been actively carried out in order to enhance the toughness of such ceramics.

In general, the toughness and strength of carbon fiber composite materials are referred to in terms of the pull-out of the carbon fiber part upon fracture of the composite material. It is known that carbon fibers pull out when a composite material is fractured, and also that as the lengths of fibers that have pulled out are longer, the composite material has improved toughness and strength (see, for example, Chemistry Handbook—Applied Chemistry, 6^{th} Edition, edited by the Chemical Society of Japan, Maruzen Co., Ltd., pp. 622-628).

As a method for obtaining a carbon fiber composite material, there is known, for example, Liquid silicon infiltration (LSI) of coating fibers with a resin to carbonize the fibers, subsequently mixing the fibers with a resin, subjecting the mixture to molding and carbonization treatments, and then subjecting the molded product to melt impregnation with silicon to allow silicon and carbon to react with each other, to thereby obtain a carbon fiber composite material formed of carbon fiber and a silicon carbide matrix (see, for example, Japanese Patent Application Publication No. 3-55430 and Japanese Patent Application Laid-Open No. 10-251065). In the case of the Liquid silicon infiltration (LSI), there is a possibility that infiltration of silicon into the molded product may lead to a chemical reaction between the carbon fiber and silicon and cause an impairment of the mechanical properties such as toughness and strength of the carbon fiber. Therefore, the carbon fibers are coated with a resin or the like for the purpose of preventing a reaction between molten silicon and the carbon fiber.

Furthermore, due to this resin coating, resin-derived carbon is formed after the production of a composite, at the interface between the carbon fibers and the silicon carbide matrix, and the carbon fibers become prone to pull-out due to the slippage at the interface between the carbon fibers and the resin-derived carbon, so that high toughness and strength are obtained.

FIG. 1A schematically shows a carbon fiber composite material in which a matrix 12 and carbon fibers 14 are alternately arranged side by side, and also shows the appearance of the carbon fibers and the matrix when the carbon fiber composite material is subjected to external stress, that is, the change occurring after the generation of a crack 16 in the matrix 12 until the breakage of the fibers. FIG. 1B shows the respective stress-strain curves of a simple ceramic substance (matrix material) and a carbon fiber composite material. As shown in FIGS. 1A and 1B, it can be seen that high toughness and strength are obtained with a carbon fiber composite material, as compared with the case where carbon fibers are absent.

However, compositization of carbon fiber and silicon carbide is carried out at a high temperature of 1400° C. or higher, and therefore, the calcination heat or reaction heat causes deterioration of the carbon fiber, leading to significant damage to the mechanical properties (dynamics properties). Accordingly, in reality, even if a resin-coated carbon fiber is used, it is difficult to create the pull-out effect only by that, and it is still difficult to obtain toughness or strength. Therefore, in order to use a carbon fiber composite material in high-reliability parts such as brakes, further toughened materials are required.

### SUMMARY OF THE INVENTION

The present invention was made to solve the problems described above, and it is an object of the invention to provide a carbon fiber composite material having excellent mechanical properties such as toughness and strength, and a brake member, a structural member for semiconductor, a heat resistant panel and a heat sink, all of which use this carbon fiber composite material.

The inventors of the present invention conducted a thorough investigation, and as a result, they found that since the elastic modulus of a carbon fiber is attributed to the crystallinity of the carbon fiber precursor, when the lattice spacing d002 of the carbon (002) plane, which represents the crystallinity of the carbon fiber precursor, is adjusted to a value in a particular range, a carbon fiber composite thus obtained acquires excellent strength and toughness. Thus, the inventors solved the problems described above and completed the invention.

The invention relates to the following items.

(1) According to one aspect of the invention, there is provided a carbon fiber composite material which is obtained by mixing carbon fiber with a resin, subsequently molding the mixture and carbonizing the molded product, and subjecting the resultant carbonized product to melt impregnation with silicon,

wherein the lattice spacing d002 of the carbon (002) plane of the carbon fiber as measured by an X-ray diffraction method is 3.46 to 3.51.

(2) The carbon fiber composite material as described in the above item (1) may have the carbon fiber coated with a phenolic resol resin.

(3) The carbon fiber composite material as described in the above item (2) may have a carbon powder dispersed in the resin used for coating the carbon fiber.

(4) The carbon fiber in the carbon fiber composite material as described in any one of the above items (1) to (3) may have a fiber length of 1 to 20 mm.

(5) The carbon fiber composite material as described in any one of the above items (1) to (4) may contain the carbon fiber in the form of a fiber bundle (tow) including 1000 to 40,000 fibers/bundle.

(6) The carbon fiber composite material as described in any one of the above items (1) to (5) may contain a phenolic novolac resin as the resin.

(7) The carbon fiber composite material as described in anyone of the above items (1) to (6) may further mixing graphite and an organic fiber when mixing carbon fiber with a resin.

(8) The carbon fiber composite material as described in the above item (7) may contain a fibrillated acrylic fiber as the organic fiber.

(9) The carbon fiber composite material as described in any one of the above items (1) to (8) may be obtained by further incorporating a silicon carbide powder during the mixing of the carbon fiber and the resin.

(10) The matrix portion of the carbon fiber composite material as described in any one of the above items (1) to (9) may contain silicon carbide as a main component.

(11) According to another aspect of the invention, there is provided a brake member which uses the carbon fiber composite material as described in any one of the above items (1) to (10).

(12) According to another aspect of the invention, there is provided a structural member for semiconductor which uses the carbon fiber composite material as described in any one of the above items (1) to (10).

(13) According to another aspect of the invention, there is provided a heat resistant panel which uses the carbon fiber composite material as described in any one of the above items (1) to (10).

(14) According to another aspect of the invention, there is provided a heat sink which uses the carbon fiber composite material as described in any one of the above items (1) to (10).

According to the invention, there may be provided a carbon fiber composite material having superior toughness and strength as compared with conventional carbon fiber composite materials, and a brake member, a structural member for semiconductor, a heat resistant panel and a heat sink, all of which use this carbon fiber composite material.

### BRIEF DESCRIPTION OF THE DRAWINGS

FIGS. 1A and 1B are diagrams modeling the fracture behavior of a ceramic material and a fiber-reinforced ceramic material;

FIG. 2 is a graphic diagram showing the relationship between the tensile modulus of carbon fiber and the d value of the (002) plane;

FIG. 3 is a photograph showing a texture of a fractured surface after the bending test of Example 1; and

FIG. 4 is a photograph showing a texture of a fractured surface after the bending test of Comparative Example 1.

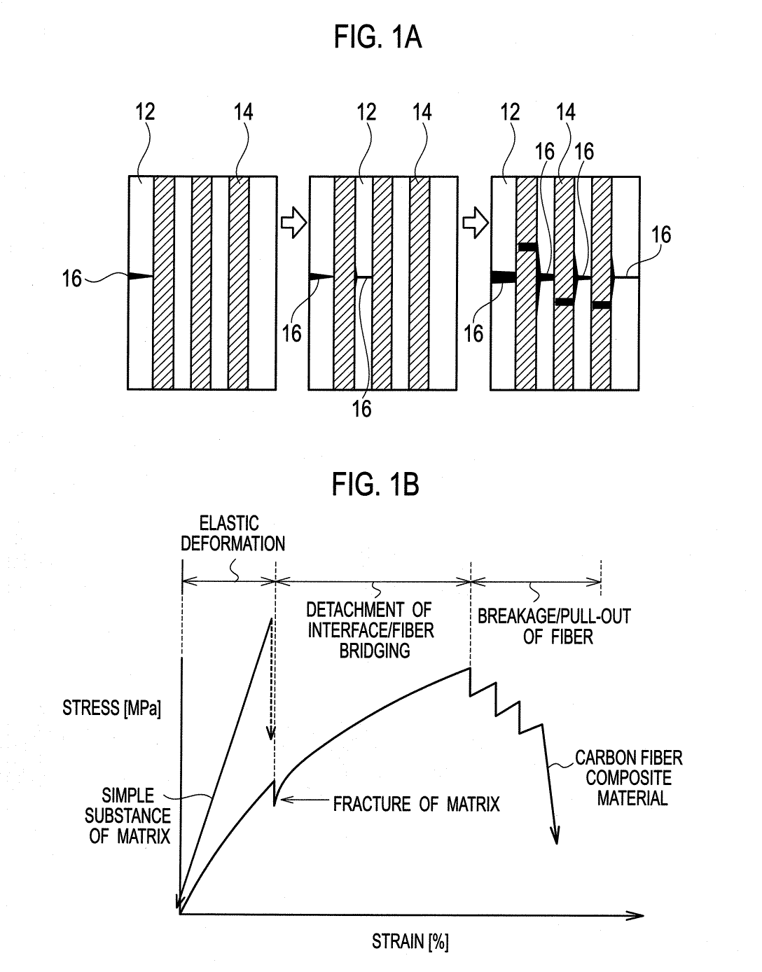

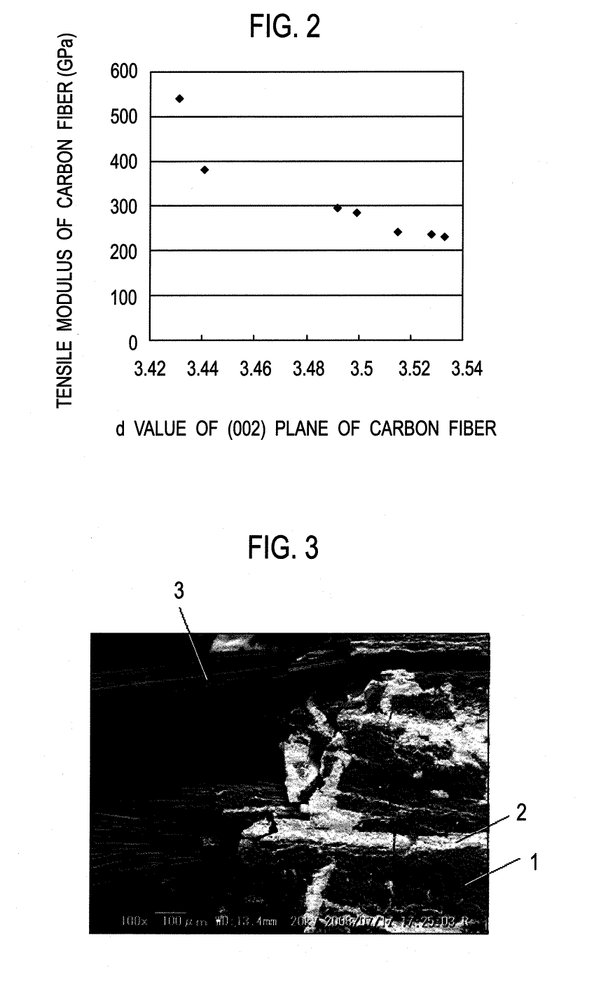

### DETAILED DESCRIPTION OF THE EMBODIMENTS

Hereinafter, the carbon fiber composite material of the invention will be described in detail.

The carbon fiber composite material of the invention is a carbon fiber composite material obtained by mixing carbon fiber with a resin, subsequently molding the mixture and carbonizing the molded product, and subjecting the resultant carbonized product to melt impregnation with silicon, and is characterized in that the lattice spacing d002 of the carbon (002) plane of the carbon fiber as measured by an X-ray diffraction method is 3.46 to 3.51.

Here, in the invention, the measurement of lattice spacing d002 of the carbon (002) plane was conducted using wide-angle X-ray diffractometer based on Japan Society for the Promotion of Science Law.

Hereinafter, the respective constituent elements of the carbon fiber composite material of the invention will be described.

### [Carbon Fiber]

The carbon fiber according to the invention is used for the purpose of increasing the toughness of a silicon carbide ceramic material (carbon fiber composite material). Examples of carbon fibers include polyacrylonitrile-based (hereinafter, may be referred to as “PAN-based”) carbon fibers and pitch-based carbon fibers, as sorted based on the difference in the precursor. The PAN-based carbon fibers and the pitch-based carbon fibers are characterized in that they are different in terms of the balance between tensile strength and elastic modulus, due to the difference in the precursor. Many PAN-based carbon fibers are likely to produce high strength fibers, and yield carbon fibers specialized in strength. Conventionally, PAN-based carbon fibers are largely classified into a standard modulus type (HT type), an intermediate modulus type (IM type) and a high modulus type (HM type), and the difference in these elastic moduli is said to be mainly caused by the difference in the calcination temperature used in the production of carbon fiber. Pitch-based carbon fibers have a feature that although the strength is inferior to that of PAN-based carbon fibers, the elastic modulus is easy to control, and therefore, there are available from low elasticity carbon fibers to ultra-high elasticity carbon fibers, which are not feasible to produce with the PAN-based carbon fibers. According to the invention, it is preferable to use a PAN-based carbon fiber for the purpose of producing a composite material having high strength and high toughness.

The carbon fiber according to the invention is characterized in that the lattice spacing d002 of the carbon (002) plane of the carbon fiber precursor as measured by an X-ray diffraction method is 3.46 to 3.51. The elastic modulus of carbon fiber is attributed to the crystallinity of the carbon fiber precursor, and when the lattice spacing d002 of the carbon (002) plane which represents the crystallinity of the carbon fiber precursor falls in the range described above, the resulting carbon fiber composite acquires excellent strength and toughness. If the lattice spacing is less than the lower limit, the toughness of the carbon fiber composite is likely to be lowered, and if the lattice spacing exceeds the upper limit, the strength of the carbon fiber composite is likely to be lowered. A preferred value of the lattice spacing d002 is 3.47 to 3.50.

Here, the value of the lattice spacing d002 is a value obtained by an X-ray diffraction method.

Furthermore, it is preferable to coat the carbon fiber used in the invention in advance with a resin. Examples of the resin used for coating (hereinafter, referred to as “resin for coating”) include a phenolic resol resin, a phenolic novolac resin, a furan resin, an imide resin, an epoxy resin, and pitch. Among them, it is preferable to perform the coating with a phenolic resol resin from the viewpoint of obtaining a high carbon yield after thermal decomposition. In addition, from the viewpoint of causing less damage in the carbon fiber due to a volume reduction upon thermal decomposition of the resin for coating, it is preferable to use an imide resin.

Furthermore, when the carbon fiber is coated, a carbon powder such as carbon black may be uniformly dispersed in the resin for coating.

There are no particular limitations on the coating method using the resin for coating, but for example, a method of impregnating carbon fiber with a resin, and then thermally decomposing the resin for coating to carbonize the resin, may be used.

From an industrial viewpoint, it is preferable to use a resin for coating from the viewpoints of shortening of the production time, simplicity of the facility, and the material cost, but in addition to the resin for coating, the carbon fiber may also be coated with, for example, carbon or boron nitride by a chemical vapor deposition (CVD) method, a physical vapor deposition (PVD) method, or the like.

The fiber length of the carbon fiber is preferably 1 to 20 mm, and more preferably 3 to 12 mm, from the viewpoints of increasing the strength of the carbon fiber composite material, increasing the toughness, and maintaining uniformity of the material strength.

Furthermore, the fiber bundle (tow) of the carbon fiber preferably includes 1000 to 40,000 fibers/bundle, and more preferably 3000 to 12,000 fibers/bundle, from the viewpoints of strength increase of the carbon fiber composite material, handleability of the carbon fiber, and impregnation properties of the resin for coating.

The carbon fiber is preferably used in an amount of 20% to 70% by weight, and more preferably 35% to 55% by weight, in the mixture with the resin.

### [Resin]

Preferred examples of the resin according to the invention include a phenolic resin, a furan resin, an imide resin, an epoxy resin, pitch and an organometallic polymer. Among these, a phenolic novolac resin is preferred as a type of the phenolic resin, from the viewpoints that the carbon yield after thermal decomposition is high, and the price is low.

Furthermore, these resins may be used singly alone, or two or more kinds may be used in combination. Among them, it is preferable to use a phenolic resin from the viewpoints that the carbon yield after thermal decomposition is high, and the material cost is low.

### [Organic Fiber]

The organic fiber used in the invention is used to produce pores uniformly in the matrix during the production process for the carbon fiber composite material of the invention, and to make the conversion of the matrix into silicon carbide more uniformly. Preferred examples of the organic fiber include an acrylic fiber, an aramid fiber, a cellulose fiber, and a natural fiber. Among them, an acrylic fiber which has a low decomposition temperature and generates a smaller amount of decomposition gas per unit temperature, is more preferred.

Furthermore, a fibrillated organic fiber is more preferred from the viewpoint of enhancing the particle dispersibility of the resin and other filler materials, and obtaining effects such as a decrease in material segregation in the matrix and an enhancement of moldability.

For the reasons described above, a fibrillated acrylic fiber is preferable as the organic fiber.

The fiber diameter of the organic fiber is preferably 10 to 60 μm, and more preferably 15 to 40 μm, from the viewpoint that it is easier for silicon to impregnate the organic fiber in the production process that will be described below.

The residual carbon ratio of the organic fiber is preferably 60% by weight or less, and more preferably 50% by weight or less, from the viewpoint that it is easier for silicon to infiltrate into the pores, and the effects of the invention are suitably exhibited.

The content of the organic fiber in the matrix produced via the step (ii) that will be described below, is preferably 1% to 15% by weight, and more preferably 2% to 10% by weight, from the viewpoint of suitably exhibiting the effects of the invention.

### [Filler Material]

The carbon fiber composite material of the invention preferably further contains a filler material. The filler material used in the invention is used for the purpose of serving as a carbon source, an aggregate or an oxidation inhibitor, enhancing the thermal conductivity, and increasing the density. Specifically, examples of filler used as a carbon source include a carbon powder, a graphite powder, and carbon black.

Furthermore, preferred examples of a filler material intended to serve as an aggregate or an oxidation inhibitor, to enhance the thermal conductivity, and increase the density, include a silicon carbide (SiC) powder, a Si powder, and an organosilicon polymer such as polycarboxysilane. These fillers may be used singly, or two or more kinds may be used in combination.

According to the invention, when the carbon fiber composite material contains graphite and an organic fiber, it is easier for the matrix to produce compact and uniform silicon carbide, and the matrix acquires high strength, high heat conductivity and high oxidation resistance, which is preferable.

Hereinafter, the invention will be described in more detail based on an example of the method for producing the carbon fiber composite material of the invention.

According to an example of the method for producing the carbon fiber composite material of the invention, the method preferably includes the steps described below:

(i) a step of mixing a carbon fiber that has been coated with a resin as desired, with a resin, and with a filler material and an organic fiber as necessary;

(ii) a step of molding the mixture obtained in the step (i) into a predetermined shape;

(iii) a step of carbonizing (calcining) the molded product obtained in the step (ii); and

(iv) a step of subjecting the carbonized product obtained in the step (iii) to melt impregnation with silicon.

According to such a production method, the matrix portion can be made to react more uniformly by melt impregnation with silicon, and a carbon fiber composite material having excellent strength properties is likely to be obtained. Hereinafter, the respective steps (i) to (iv) will be described in detail.

(i) A Step of Mixing a Carbon Fiber that has been Coated with a Resin as Desired, with a Resin, and with a Filler Material and an Organic Fiber as Necessary

The resin used in the invention takes the role as a binder when the mixture is molded into a predetermined shape in the step (ii), and the role as a carbon source for reacting with molten silicon and thereby producing a silicon carbide matrix in the step (iv).

The details of the carbon fiber, resin, filler material and organic fiber are the same as described above, and thus further descriptions on the components will not be given here.

There are no particular limitations on the method of mixing the carbon fiber, resin, filler material and organic fiber, as long as the method allows these components to be uniformly mixed. However, from the viewpoints of shortening the production time and lowering the facility cost, a dry mixing method is more preferred, and it is preferable to mix the components using, for example, a Lodige mixer, an Eirich mixer or the like.

The mixing ratio (percentage by volume) of the respective components of the mixture obtained by mixing in the step (i) is preferably 20% to 40% by volume of the resin, 3% to 40% by volume of the filler, 1.5% to 6% by volume of the organic fiber, 25% to 60% by volume of the carbon fiber, and 5% to 25% by volume of the resin for coating.

In addition, there are no particular limitations on the content ratio of the silicon carbide-based matrix and the carbon fiber in the carbon fiber composite material, and the content ratio is appropriately selected in accordance with the use of the composite material. However, the content ratio is usually selected such that the content of the carbon fiber is in the range of 15% to 65% by volume.

According to the invention, it is also possible to use a carbon fiber-woven fabric as the carbon fiber. In the case of using a carbon fiber-woven fabric, the carbon fiber composite material is produced by applying a slurry prepared by blending a resin and a filler on a carbon fiber-woven fabric, subsequently laminating a carbon fiber-woven fabric thereon, drying the assembly to obtain a laminate, and then carrying out subsequent steps that are equivalent to the steps (ii) to (iv).

(ii) A Step of Molding the Mixture Obtained in the Step (i) into a Predetermined Shape

There are no particular limitations on the molding method as long as the method is a method capable of molding the mixture obtained in the step (i) without uneven distribution of the mixture, and for example, a method of introducing the mixture into a preheated mold and performing hot press molding, may be used. Furthermore, there are no particular limitations on the “predetermined shape,” and the mixture can be processed into any shape appropriate for the respective uses to which the invention is applied.

The molding temperature is appropriately selected depending on the resin used, but for example, in the case of a phenolic resin, it is preferable to perform the molding at a temperature of 100° C. to 250° C., more preferably 120° C. to 230° C., and even more preferably 130° C. to 200° C.

In regard to the molding pressure, it is preferable to perform the molding at a pressure of 1 to 70 MPa, more preferably 10 to 60 MPa, and even more preferably 25 to 40 MPa.

(iii) A Step of Carbonizing (Calcining) the Molded Product Obtained in the Step (ii)

The carbonization method is carried out by a high temperature heat treatment under an inert atmosphere. In regard to the calcination temperature, it is preferable to perform the calcination at a temperature of 500° C. to 2000° C., more preferably 600° C. to 1800° C., and even more preferably 900° C. to 1500° C. Examples of the inert atmosphere include an argon atmosphere and a nitrogen atmosphere. Among them, an argon atmosphere is more preferred in view of high temperature stability.

(iv) A Step of Subjecting the Carbonized Product Obtained in the Step (iii) to Melt Impregnation with Silicon

There are no particular limitations on the impregnation temperature, as long as it is a temperature equal to or higher than the melting point of silicon. There are no particular limitations on the type of the atmosphere as long as the atmosphere allows uniform impregnation of silicon, and for example, a vacuum or an inert atmosphere such as an argon atmosphere may be used. The silicon used in the impregnation preferably has a purity of 99% or higher, more preferably 99.5 or higher, and even more preferably 99.9% or higher.

It is preferable that the matrix portion of the carbon fiber composite material obtained as described above, contain silicon carbide as a main component. Here, it is meant by the term “main component” that the corresponding component is present in the matrix at a proportion of more than 50%.

Due to the excellent mechanical properties such as toughness and strength, the carbon fiber composite material of the invention can be used in a large number of applications such as a brake member for automobiles and bicycle disk rotors, a structural member for semiconductor, a structural member for high temperature use in aerospace, a heat resistant panel, a heat sink, a member for gas turbine, a material for nuclear fusion furnace, a member for furnace interior, and a heater member.

### EXAMPLES

Hereinafter, the invention will be described in more detail by way of Examples and Comparative Examples, but the invention is not intended to be limited to any of these Examples.

In the respective Examples and Comparative Examples, raw materials except for carbon fiber were blended according to the blending proportions (percentage by volume) indicated in the following Tables 1 and 2, and the mixture was mixed with a Lodige mixer (trade name: Lodige Mixer M20, manufactured by Matsubo Corporation). Thereafter, the mixture powder was mixed with a carbon fiber coated with a phenolic resin and having a fiber length of 6 mm, in a V-blender, and thereby a blend composition was obtained. This blend composition was subjected to hot press molding to obtain a shape which measured 100 mm on each side and 6.5 mm in thickness, for 15 minutes under the conditions of a molding temperature of 155° C. and a molding pressure of 30 MPa using a molding press (manufactured by Sanki Seiko Co., Ltd.). Subsequently, this molded product was carbonized for one hour at 900° C. in a nitrogen atmosphere using a high temperature atmosphere furnace (manufactured by Motoyama Co., Ltd.). This calcination product thus obtained was subjected to melt impregnation with silicon for 30 minutes at 1450° C. in a vacuum using a vacuum heating furnace (Research Assist, Inc.), and thus a carbon fiber composite material was obtained.

In the Tables 1 and 2, the term “d” in “d=3.449” and the like means the lattice spacing d002 of the carbon (002) plane.

TABLE 1

| | | | Example | | | | | | |
|---|---|---|---|---|---|---|---|---|---|
| Name of material | | Name of Manufacturer, Trade name | 1 | 2 | 3 | 4 | 5 | 6 | 7 |
| Binding | Phenolic | HP491UP, manufactured by | 30 | 29 | 29 | 28 | 29 | 28 | 28 |
| material | resin | Hitachi Chemical Co., Ltd. | | | | | | | |
| (resin) | | | | | | | | | |
| Filler | Graphite | HAG-150, manufactured by | 7 | 8 | 8 | 4 | 9 | 8 | 8 |
| material | powder | Nippon Graphite Industries, Ltd. | | | | | | | |
| | SiC powder | GC#4000, manufactured by | — | — | — | 4 | — | — | — |
| | | Fujimi Corporated | | | | | | | |
| Organic | Acrylic fiber | CFF V110-1, manufactured by | 2.0 | 2.5 | 2 | 2 | 3 | 2 | 2 |
| fiber | | STERLING FIBERS, Inc. | | | | | | | |

| | | | | | | | | | |
|---|---|---|---|---|---|---|---|---|---|
| Carbon fiber | IM600-24k, manufactured by | d = 3.499 | 40 | 40 | — | — | — | — | — |
| | Toho Tenax Co., Ltd. | | | | | | | | |
| | IM600-12k, manufactured by | | — | — | 40 | 40 | — | — | — |
| | Toho Tenax Co., Ltd. | | | | | | | | |
| | IM600-6k, manufactured by | | — | — | — | — | 40 | — | — |
| | Toho Tenax Co., Ltd. | | | | | | | | |
| | IM400-12k, manufactured by | d = 3.492 | — | — | — | — | — | 40 | — |
| | Toho Tenax Co., Ltd. | | | | | | | | |
| | IM400-12k, manufactured by | d = 3.474 | — | — | — | — | — | — | 40 |
| | Toho Tenax Co., Ltd., | | | | | | | | |
| | Product heated-treated at | | | | | | | | |
| | 1500° C. in Ar atmosphere | | | | | | | | |

| | | | | | | | | | |
|---|---|---|---|---|---|---|---|---|---|
| Coating | Phenolic | BRL-120Z, manufactured by | 21 | 20 | 21 | 22 | 19 | 22 | 22 |
| material | resin | Showa High Polymer Co., Ltd | | | | | | | |
| | Carbon | Denka Black, manufactured by | — | 0.5 | — | — | — | — | — |
| | powder | Denki Kagaku Kogyo Kabushiki Kaisha | | | | | | | |

| | | | | | | | |
|---|---|---|---|---|---|---|---|
| Average flexural strength [MPa] | 91 | 83 | 102 | 105 | 110 | 96 | 90 |
| Toughness [value relative to Comparative Example 1] | 2.5 | 2.7 | 2.1 | 2.3 | 2.5 | 3.1 | 2.1 |
| Bulk density [g/cm³] | 2.0 | 1.9 | 2.0 | 2.1 | 2.0 | 2.0 | 2.0 |
| Open porosity [%] | 1.5 | 1.8 | 1.7 | 1.5 | 1.0 | 1.5 | 1.5 |
| Presence or absence of pull-out of carbon fiber | Present | Present | Present | Present | Present | Present | Present |
| under SEM observation [%] | | | | | | | |

TABLE 2

| | | | Comparative Example | | | | | |
|---|---|---|---|---|---|---|---|---|
| Name of material | | Name of Manufacturer, Trade name | 1 | 2 | 3 | 4 | 5 | 6 |
| Binding | Phenolic | HP491UP, manufactured by Hitachi Chemical Co., Ltd. | 29 | 35 | 29 | 28 | 30 | 30 |
| material | resin | | | | | | | |
| (resin) | | | | | | | | |
| Filler | Graphite | HAG-150, manufactured by Nippon Graphite Industries, Ltd. | 8 | 0 | 8 | 8 | 8 | 8 |
| material | powder | | | | | | | |
| Organic | Acrylic | CFF V110-1, manufactured by STERLING FIBERS, Inc. | 2 | 2 | 2 | 2 | 2 | 2 |
| fiber | fiber | | | | | | | |

| | | | | | | | | |
|---|---|---|---|---|---|---|---|---|
| Carbon fiber | HTA-12k, manufactured by Toho Tenax Co., Ltd. | d = 3.528 | 40 | 40 | — | — | — | — |
| | T300-6k, manufactured by Toray Industries, Inc. | d = 3.533 | — | — | 40 | — | — | — |
| | UT500-12k, manufactured by Toho Tenax Co., Ltd. | d = 3.515 | — | — | — | 40 | — | — |
| | UM40-12k, manufactured by Toho Tenax Co., Ltd. | d = 3.441 | — | — | — | — | 40 | — |
| | UM55-12k, manufactured by Toho Tenax Co., Ltd. | d = 3.431 | — | — | — | — | — | 40 |

| | | | | | | | | |
|---|---|---|---|---|---|---|---|---|
| Coating | Phenolic | BRL-120Z,, manufactured by Showa High Polymer Co., Ltd. | 21 | 23 | 21 | 22 | 20 | 20 |
| material | resin | | | | | | | |

| | | | | | | |
|---|---|---|---|---|---|---|
| Average flexural strength [MPa] | 90 | 65 | 86 | 84 | 70 | 109 |
| Toughness [value relative to Comparative Example 1] | 1.0 | 0.6 | 0.9 | 0.9 | 0.6 | 1.2 |
| Bulk density [g/cm³] | 1.9 | 2.0 | 1.9 | 1.9 | 2.1 | 2.1 |
| Open porosity [%] | 1.5 | 1.6 | 1.5 | 1.9 | 2 | 2 |
| Presence or absence of pull-out of carbon fiber | Absent | Absent | Absent | Absent | Absent | Absent |
| under SEM observation [%] | | | | | | |

The flexural strength of the composite materials thus obtained was measured according to the bending strength test method of Ceramics JIS R1601. Specifically, the test was carried out using Tensilon UTA-300kN manufactured by Orientec Company, at a testing rate of 0.5 mm/min, a fulcrum distance of 30 mm, and a testing temperature of 23° C., with a specimen having a thickness of 3±0.1 mm, a width of 4±0.1 mm and a length of 37±0.1 mm.

The toughness of the composite materials thus obtained was evaluated based on the integral value of a stress-displacement curve (fracture energy) obtained by the bending strength test.

The open porosity and density of the composite materials thus obtained were measured according to the method of Ceramics JIS R1634 for measuring the density and open porosity of a sintered body.

Observations were made on the composite materials thus obtained in their backscattered electronic images under a scanning electron microscope (trade name: Real Surface View Microscope KEYENCE VE-7800, manufactured by Keyence Corporation).

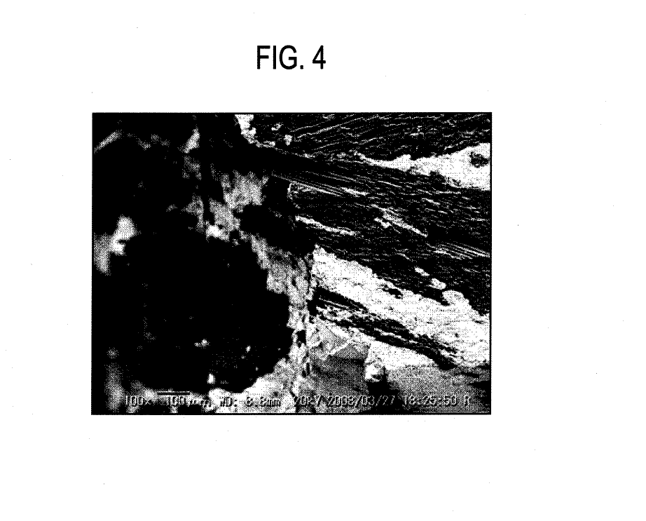

In the carbon fiber composite materials indicated as Comparative Examples in Table 2, the pull-out of carbon fiber from the fractured surfaces was hardly observed as shown in FIG. 4. On the other hand, in the carbon fiber composite materials using a carbon fiber having a particular d value (d002) which are indicated as Examples in Table 1, significant pull-out of carbon fiber was observed as shown in FIG. 3. Even from a comparison of toughness, the carbon fiber composite materials of the Examples had their toughness improved to about 3 times at the maximum. Therefore, it was found that when a carbon fiber having a particular d value is used, the composite material can acquire significantly increased toughness.

1. A carbon fiber composite material, obtained by mixing carbon fiber with a resin, subsequently molding the mixture and carbonizing the molded product, and subjecting the resultant carbonized product to melt impregnation with silicon,
wherein the lattice spacing d002 of the carbon (002) plane of the carbon fiber as measured by an X-ray diffraction method is 3.46 to 3.51.

2. The carbon fiber composite material according to claim 1, wherein the carbon fiber is coated with a phenolic resol resin.

3. The carbon fiber composite material according to claim 2, wherein a carbon powder is dispersed in the resin used for coating the carbon fiber.

4. The carbon fiber composite material according to claim 1, wherein the carbon fiber has a fiber length of 1 to 20 mm.

5. The carbon fiber composite material according to claim 1, wherein the carbon fiber is in the form of a fiber bundle (tow) including 1000 to 40,000 fibers/bundle.

6. The carbon fiber composite material according to claim 1, wherein the resin is a phenolic novolac resin.

7. The carbon fiber composite material according to claim 1, further mixing graphite and an organic fiber when mixing carbon fiber with a resin.

8. The carbon fiber composite material according to claim 7, wherein the organic fiber is a fibrillated acrylic fiber.

9. The carbon fiber composite material according to claim 1, obtained by further incorporating a silicon carbide powder during the mixing of the carbon fiber and the resin.

10. The carbon fiber composite material according to claim 1, wherein the matrix portion of the carbon fiber composite material contains silicon carbide as a main component.

11. A brake member, using the carbon fiber composite material according to claim 1.

12. A structural member for semiconductor, using the carbon fiber composite material according to claim 1.

13. A heat resistant panel, using the carbon fiber composite material according to claim 1.

14. A heat sink, using the carbon fiber composite material according to claim 1.

15. A brake member, using the carbon fiber composite material according to claim 2.

16. A structural member for semiconductor, using the carbon fiber composite material according to claim 2.

17. A heat resistant panel, using the carbon fiber composite material according to claim 2.

18. A heat sink, using the carbon fiber composite material according to claim 2.

19. A brake member, using the carbon fiber composite material according to claim 3.

20. A structural member for semiconductor, using the carbon fiber composite material according to claim 3.

21. A heat resistant panel, using the carbon fiber composite material according to claim 3.

22. A heat sink, using the carbon fiber composite material according to claim 3.
